(19) United States
(12) Patent Application Publication
(10) Pub. No.: US 2015/0020634 A1
(43) Pub. Date: Jan. 22, 2015

(54) LEVER STYLE ELECTRONIC SHIFTER WITH CONCEALED LEVER POSITION

(71) Applicants: Jay T. TenBrink, Goodrich, MI (US); Robert L. Brown, Clarkston, MI (US)

(72) Inventors: Jay T. TenBrink, Goodrich, MI (US); Robert L. Brown, Clarkston, MI (US)

(21) Appl. No.: 13/945,000

(22) Filed: Jul. 18, 2013

(51) Int. Cl. F16H 59/02

(52) U.S. Cl. CPC F16H 59/0278; F16H 2059/0221; F16H 2059/0286
USPC 74/473.33

(57) ABSTRACT

A poly-stable electronic shifter assembly can include a poly-stable shift lever, a shift knob, a park, reverse, neutral and drive (PRND) indication area and a flexible member. The shift lever can be coupled to a base proximate a first end of the shift lever. The shift knob can be coupled to a second end of the shift lever. The PRND indication area can be associated with the shift knob. The flexible member can be positioned about the shift lever between the shift knob and the base such that the flexible member covers the shift lever and conceals a physical location of the shift lever when positioned in one of a PRND gear selection location. The PRND indication area can be disassociated with the PRND gear selection locations such that the PRND indication area includes an absence of alignment with the shift lever in the PRND gear selection locations.

### FIELD

The present disclosure relates generally to a poly-stable lever style electronic shifter and, more particularly, to a poly-stable lever style electronic shifter with a concealed lever position.

### BACKGROUND

More and more vehicles are being equipped with electronic shifter (“e-shifters”) to place the vehicle's automatic transmission into a desired gear state. Electronic shifters can replace the traditional console mounted P-R-N-D-L mechanical shift lever and are typically implemented as levers, which can be pushed up/down or sideways, and/or buttons to effect gear changes. The typical lever type electronic shifter returns to its original or home position after it has been manipulated by the driver. As such, there is typically an indication adjacent to the electronic shifter lever providing a gear position indicator to visually show the driver what gear the vehicle is in.

A more recent development is to have a multi-position stable or poly-stable e-shifter that retains an actuator setting that represents a driver requested transmission gear state. With the poly-stable e-shifter, the shift lever can retain a manipulated position of the shift lever and, as such, is preferred by many drivers. For example, when a center console mounted poly-stable e-shifter lever is manipulated to a position to place the transmission into a drive gear, the shift lever can maintain that position in-line with an indication of “Drive” or “D” on a center console surface.

There are times, however, that the gear selected by the e-shifter may not match the transmission's actual gear position. This may occur, for example, when the vehicle operator attempts a transmission gear change that the vehicle is programmed not to make (e.g., to prevent an unintended condition and/or potential damage to the transmission). As an example, a vehicle is typically programmed to prevent it from being placed into reverse (R) when the vehicle's forward speed is above a certain speed threshold. When this happens, the e-shifter lever position, as perceived by the driver and/or another vehicle occupant will be in-line with a gear indication, e.g., (R), that does not match the actual transmission gear, e.g., (D). Accordingly, there is a need for improvement in the relevant art.

### SUMMARY

In one form, a poly-stable electronic shifter assembly is provided in accordance with the teachings of the present disclosure. The poly-stable electronic shifter assembly can include a poly-stable shift lever, a shift knob, a park, reverse, neutral and drive (PRND) indication area and a flexible member. The poly-stable shift lever can be coupled to a base proximate a first end of the poly-stable shift lever. The shift knob can be coupled to the poly-stable shift lever at a second end opposite the first end. The PRND indication area can be associated with the shift knob. The flexible member can be positioned about the poly-stable shift lever between the shift knob and the base such that the flexible member covers the poly-stable shift lever and conceals a physical location of the poly-stable shift lever when positioned in one of a park, reverse, neutral and drive (PRND) gear selection location. The PRND indication area can be disassociated with the PRND gear selection locations such that the PRND indication area includes an absence of alignment with the physical locations of the poly-stable shift lever in the PRND gear selection locations.

In another form, a poly-stable electronic shifter assembly is provided in accordance with the teachings of the present disclosure. The poly-stable electronic shifter assembly can include a poly-stable shift lever, a shift knob, a park, reverse, neutral and drive (PRND) indication area and a boot. The poly-stable shift lever can be coupled to a base proximate a first end of the poly-stable shift lever. The shift knob can be coupled to the poly-stable shift lever at a second end opposite the first end. The PRND indication area can be positioned on an upper end of the shift knob. The boot can engage the shift knob and can be positioned about the poly-stable shift lever such that the boot covers the poly-stable shift lever and conceals a physical location of the poly-stable shift lever when positioned in one of a park, reverse, neutral and drive (PRND) gear selection location. The PRND indication area can be disassociated with the PRND gear selection locations such that the PRND indication area includes an absence of alignment with the physical locations of the poly-stable shift lever in the PRND gear selection locations.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an exemplary poly-stable shifter assembly associated with an exemplary center console of a vehicle interior according to the principles of the present disclosure;

FIG. 2A is a perspective view of the poly-stable electronic shifter assembly of FIG. 1 with a flexible member removed according to the principles of the present disclosure;

FIG. 2B is a schematic view of an exemplary shift pattern illustrating gate guide positions of a shift lever according to the principles of the present disclosure;

FIG. 3A is a side view of the poly-stable electronic shifter assembly illustrating the shift lever in various transmission gear selection locations according to the principles of the present disclosure;

FIG. 3B is a schematic view of shift lever in certain transmission gear selection locations according to the principles of the present disclosure; and

FIG. 4 is a perspective view of the poly-stable electronic shifter assembly illustrating the shift lever in various transmission gear selection locations according to the principles of the present disclosure.

### DESCRIPTION

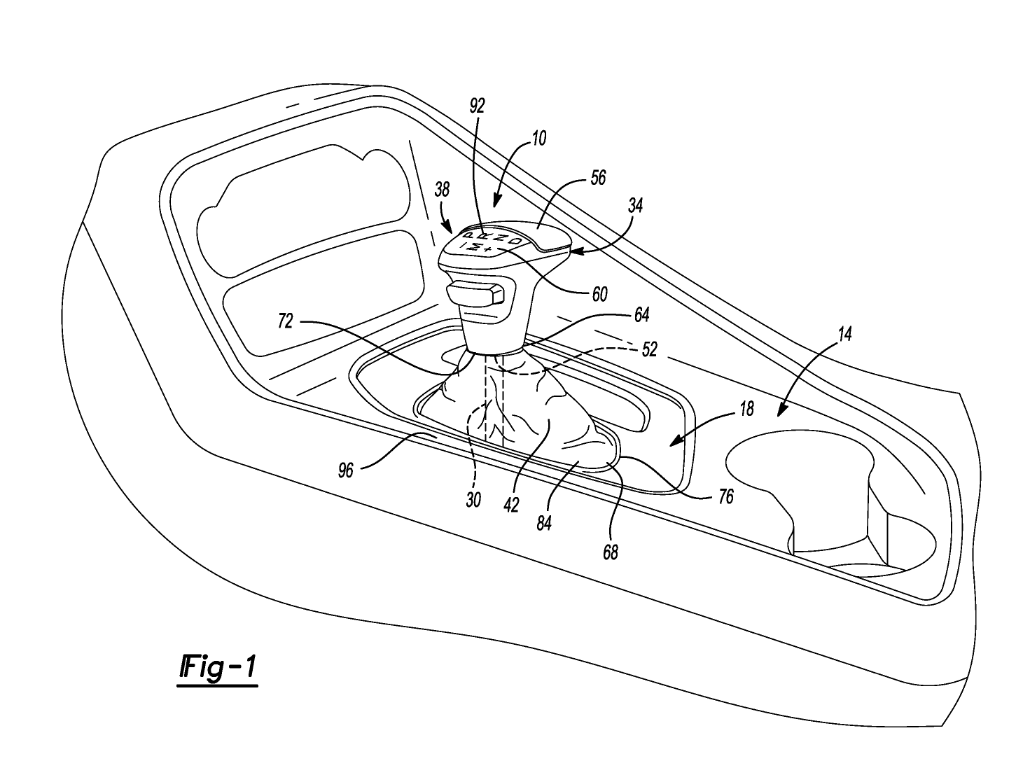

With initial reference to FIG. 1, an exemplary poly-stable electronic shifter assembly is shown and generally identified at reference numeral 10. As shown, the poly-stable electronic shifter assembly 10 can be associated with a center console 14 of an interior of a vehicle. In the exemplary implementation illustrated in FIG. 1, the poly-stable electronic shifter assembly 10 can be surrounded by a trim panel or member 18, such as an interior surface panel. It should be appreciated, however, that the poly-stable electronic shifter assembly 10 could be packaged in the vehicle's interior in various different configurations, including positions other than the center console 14 (e.g., an instrument panel) and with or without trim member 18.

As discussed above, one of the benefits of a poly-stable electronic shifter includes an ability for a shift lever to remain in a position it is placed in by a driver for selecting a transmission gear. Typical transmission gears to be selected are park, reverse, neutral and drive (PRND). If the transmission is not able to honor the driver's request (e.g., the shift lever is placed in a reverse gear selection location while the vehicle is moving forward in a drive state), a potential mis-match between the physical shift lever position and the transmission state can occur. It is undesirable for there to be a visual indication of such a potential mis-match to the driver or other occupant.

Accordingly, a poly-stable electronic shifter assembly for a shift-by-wire automatic transmission is provided in accordance with various aspects of the present disclosure. The poly-stable electronic shifter assembly can include a concealed lever position together with a disassociated park, reverse, neutral and drive (PRND) indication area so as to remove or substantially remove an opportunity to associate the shift lever position with a transmission state. This can, in turn, remove such a visual indication of the potential mis-match discussed above.

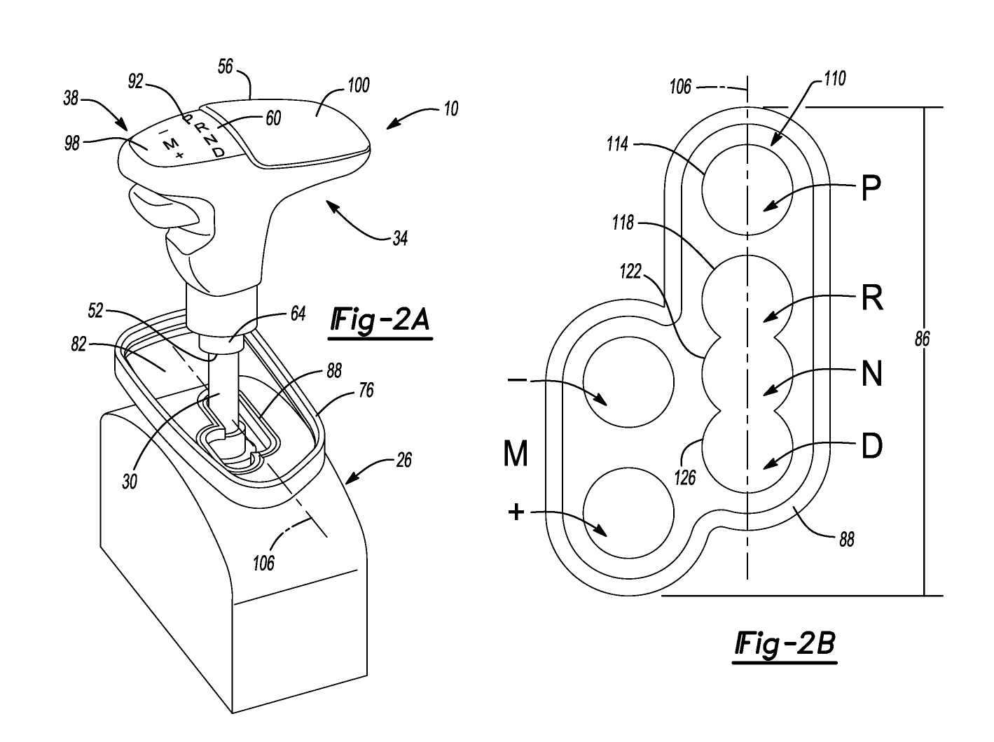

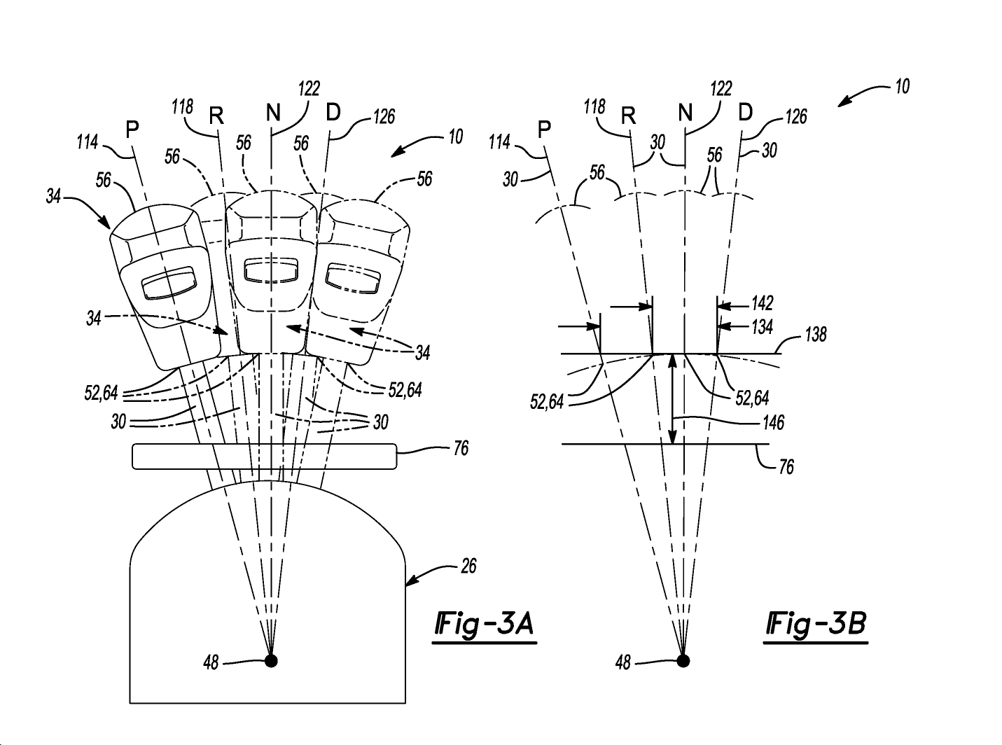

With continuing reference to FIG. 1 and additional reference to FIG. 2A, the poly-stable electronic shifter assembly 10 can include a base 26, a shift lever 30, a shift knob 34, a PRND indication area 38, and a flexible member or boot 42. The shift lever 30 can include a first end 48 (FIG. 3A) pivotably coupled to base 26 and a second opposed end 52. The shift knob 34 can be coupled or attached to the shift lever 30 at the second end 52 thereof, as shown for example in FIGS. 1 and 2A. The shift knob 34 can include an upper end 56 having an upper surface 60 and an opposed lower end 64. In the exemplary configuration illustrated, the lower end 64 of the shift knob 34 can be coupled to the shift lever 30.

The flexible member or boot 42 can include a first end or end area 68 and a second opposed end or end area 72. The second end 72 can be coupled or fitted to the poly-stable electronic shifter assembly 10 proximate the shift knob 34. In one exemplary configuration, the second end 72 of the boot 42 can be fitted to the shift lever 30 proximate its second end 52 or to the lower end 64 of the shift knob 34. In the exemplary configuration illustrated in FIG. 1, the second end 72 of boot 42 can be fitted to the lower end 64 of shift knob 34.

The first end 68 of boot 42 can be coupled or fitted to the center console 14 and/or trim panel 18, the base 26, a bezel 76 or any combination thereof such that the boot 42 conceals the shift lever 30 and any gear selection locations thereof. In one exemplary configuration, the first and second end areas 68, 72 of boot 42 are coupled as discussed above so as to conceal all components of the poly-stable electronic shifter assembly 10 below the lower end 64 of shift knob 34. In the exemplary configuration illustrated, the base 26 can be positioned inside or under, or substantially under a top or outer surface 80 of center console 14. In this exemplary implementation, the poly-stable shift lever 30 can extend through an aperture 82 in the trim component 18 and/or bezel 76 and move relative thereto. The first end area 68 of boot 42 can be fixed relative to the trim component 18 and/or bezel 76 and the second end 72 and portions therebetween of boot 42 can move with movement of the poly-stable shift lever 30.

As can be seen in FIG. 1, and by the size and shape of the bezel 76, the boot 42 can be sized and shaped to conceal a position of the shift lever 30 when it is positioned in any one of the PRND transmission gear selection locations of poly-stable shift lever 30, as will be discussed in greater detail below. For example, the boot 42 can be sized and shaped such that the second end 72 has a width or diameter larger than a diameter of the shift lever 30 thereby aiding in concealing a specific PRND gear selection location of the shift lever 30, as can be seen in FIG. 1. In this example, the lower end 64 of shift knob 34 includes a width or diameter larger than the width or diameter of shift lever 30 and that corresponds to the width or diameter of the second end 72 of boot 42. The first end area 68 of boot 42 can include an overall size or footprint 84 that is significantly larger and/or longer than a length of a gate guide 88 (FIG. 2A) of base 26 so as to further aid in concealing a specific PRND gear selection location of the shift lever 30.

The boot 42 can be made of any suitable flexible material having appropriate aesthetic and durability characteristics for use in an interior of a vehicle. In one exemplary implementation, the boot 42 can be formed out of leather or another similar natural material. In other implementations, the boot could be formed from a synthetic material or a combination of natural and synthetic materials Regardless of the material, the boot 42 can be formed and installed on the poly-stable electronic shifter assembly 10 and/or vehicle to conceal the shift lever 30 and its positions in the PRND gear selection locations.

The PRND indication area 38 can, in one exemplary implementation, be positioned on the shift knob 34. Positioning the PRND indication area 38 on the shift knob 34 can prevent a possibility for visual alignment of the shift lever 30 with one of the specific PRND indications 92 of PRND indication area 38. For example and with reference to FIG. 1, if the PRND indication area 38 was positioned on the trim panel 18 in an area 96 and arranged to match the PRND gear selection locations shown in FIGS. 2B and 3A, then a driver could more easily observe that a physical position of the shift lever 30 was mis-matched from a state of the transmission with a shifter assembly that also does not use a boot 42.

Continuing with this example, the mis-match could be more easily seen because the PRND indications 92 would align with the shift lever 30 in each of the PRND gear selection locations of the shift lever 30. In this regard, if the shift lever 30 was placed in the R gear selection location and thus in alignment with the R indication that would be on the trim panel 18 (in this example), the driver would more easily recognize a mis-match between the position of the shift lever 30 and the state of the transmission in drive (D) due to the visual alignment of the shift lever 30 and the R indication in area 96.

Accordingly, the PRND indication area 38 can be disassociated from any position that could visually align with a position of the shift lever 30 in any one of the PRND gear selection locations. In the exemplary configuration of poly-stable electronic shifter assembly 10 illustrated, the PRND indication area 38 can be positioned on the upper surface 60 of the shift knob 34. Positioning the PRND indication area 38 on the shift knob 34 can remove a visual opportunity for the driver to associate the shift lever 30 position with the transmission state. It should be appreciated, however, that the PRND indication area can also be positioned in other areas that are disassociated from any position that could visually align with a position of the shift lever 30 in any one of the PRND gear selection locations.

In one exemplary configuration, the upper surface 60 of shift knob 34 can include a first portion 98 and a second portion 100. The first portion 98 can be smaller than the second portion 100 and can extend from a first lateral side of the shift knob 34 toward an opposed second lateral side of shift knob 34. The second portion 100 can extend from the second lateral side toward the first lateral side until meeting the first portion 98. In this exemplary configuration, the PRND indication area 38 can form the first portion 98.

With additional reference to FIGS. 2A-4, the poly-stable shift lever 30 is shown in the PRND gear selection locations, as well as in manual-automatic positions (e.g., “+” and “−”). For purposes of this discussion, the manual-automatic positions will not be discussed in detail herein. With particular reference to FIGS. 2A-2B, the base 26 can include a gate guide 88 positioned relative to an upper end 102 of base 26. The gate guide 88 can include a longitudinal axis or path 106 along which the shift lever can pivot or move among the PRND gear selection locations 110. As discussed above, the PRND gear selection locations 110 can include a park (P) gear selection location 114, a reverse (R) gear selection location 118, a neutral (N) gear selection location 122, and a drive (D) gear selection location 126.

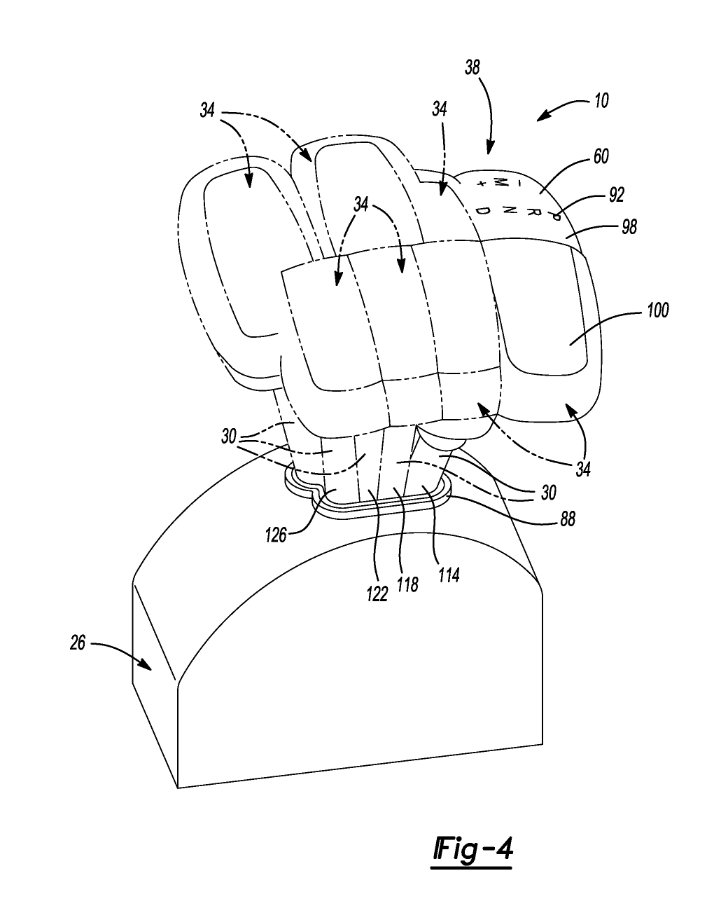

The poly-stable electronic shifter assembly 10 can be designed such that an overall distance 134 that the poly-stable shift lever 30 travels long longitudinal path 106 between the PRND gear selection locations 110 is minimized. This minimized distance 134 can aid in removing an opportunity for the driver to visually perceive a specific physical location of the shift lever among the PRND gear selection locations 110. As can be seen schematically in FIG. 2A and in more detail in the perspective views of FIGS. 3A and 4, the overall distance 134 is minimized such that the shift lever 30 gear selection locations can overlap for at least the R, N and D locations 118, 122, 126. This minimization of travel distance to the point of overlap at a reference location of the gate guide 88 or bezel 76 can aid in removing an opportunity for the driver to associate the shift lever 30 position with a transmission state.

In one exemplary implementation, the overall travel distance 134 can be less than approximately 50 mm from P to D at a reference location of approximately the lower end 64 of the shift knob 34, as shown in FIG. 3B with reference to FIG. 3A. For example, a plane 138 adjacent the lower end 64 of the shift knob 34 when in the N position can be used as the reference location for the overall distances discussed herein. In this example, the plane 138 can be parallel or substantially parallel to the bezel 76 and/or trim component 18.

In this exemplary implementation, an overall travel distance 142 between the R and D shift lever gear selection locations can be less than approximately 30 mm as measured relative to or substantially relative to plane 138. The overall travel distances 134, 142 can be measured relative to a center of the shift lever 30, as shown for example in FIGS. 3A and 3B.

The poly-stable electronic shifter assembly 10 can also be designed such that an overall height 146 of the shift lever 30 between the bezel 76 and/or trim panel 18 and shift knob 34 can be minimized. Minimizing this height 146 can be a factor in limiting the overall distances 134, 142 as the poly-stable shift lever 30 pivots about the first end 48. Minimizing the distance 142 in connection with the large footprint 84 of the boot 42 can aid in removing the opportunity to associate the poly-stable shift lever 30 position with the transmission state.

In the exemplary configuration illustrated, the shift lever 30 overall height 146 from the bezel 76 or trim panel 18 can be less than approximately 45 mm. In one exemplary implementation, the height 146 can be less than approximately 40 mm. In another implementation, the height 146 can be approximately 38 mm. In the exemplary implementations discussed above, the height 146 can be measured from the bezel 76 or trim panel 18 to the lower end 64 of the shift knob 34.

Thus the poly-stable electronic shifter assembly 10 can include the concealed poly-stable shift lever and position together with the disassociated PRND indication area 38 so as to remove an opportunity for the driver to associate the poly-stable shift lever position with a transmission state. The poly-stable electronic shifter assembly 10 can also include a minimized shift lever travel distance 134, 142 and a low profile established by the minimized height 146 to further aid in removing the opportunity for the driver to associate a physical location of the shift lever with the transmission state.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A poly-stable electronic shifter assembly, comprising:
a poly-stable shift lever coupled to a base proximate a first end of the poly stable shift lever;
a shift knob coupled to the poly-stable shift lever at a second end opposite the first end;
a park, reverse, neutral, and drive (PRND) indication area associated with the shift knob; and
a flexible member positioned about the poly-stable shift lever between the shift knob and the base such that the flexible member covers the poly-stable shift lever and conceals a physical location of the poly-stable shift lever when positioned in one of a park, reverse, neutral and drive (PRND) gear selection location;
wherein the PRNDL indication area is disassociated with the PRND gear selection locations such that the PRND indication area includes an absence of alignment with the physical locations of the poly-stable shift lever in the PRND gear selection locations.

2. The poly-stable electronic shifter assembly of claim 1, wherein the PRND indication area is positioned on an upper surface of the shift knob.

3. The poly-stable electronic shifter assembly of claim 1, wherein the flexible member includes a first end adapted to be coupled to a vehicle trim component proximate the base and a second opposite end coupled to a lower end of the shift knob.

4. The poly-stable electronic shifter assembly of claim 3, wherein the flexible member comprises a boot.

5. The poly-stable electronic shifter assembly of claim 3, wherein the poly-stable shift lever is configured to extend through an aperture of and move relative to the vehicle trim component, the aperture being covered by the flexible member; and
wherein the vehicle trim component includes an absence of the PRND indication area such that the PRND indication area is disassociated with the PRND gear selection locations of the poly-stable shift lever.

6. The poly-stable electronic shifter assembly of claim 5, wherein the vehicle trim component includes one or both of an interior surface panel and a bezel.

7. The poly-stable electronic shifter assembly of claim 6, wherein the poly-stable shift lever includes a low profile having a height from the one or both of the interior surface panel and bezel to a lower end of the shift knob of approximately 40 mm to 45 mm.

8. The poly-stable electronic shifter assembly of claim 7, wherein the height from the one or both of the interior surface panel and bezel to the lower side of the shift knob is less than approximately 40 mm.

9. The poly-stable electronic shifter assembly of claim 7, wherein the poly-stable shift lever moves along an axial path among the PRND gear selection locations; and
wherein an overall distance the poly-stable shift lever moves along the axial path from the park gear selection location to the drive gear selection location is less than approximately 50 mm, the overall distance being measured at a plane positioned substantially parallel to the one or both of the interior surface panel and bezel and adjacent the lower end of the shift knob when the poly-stable shift lever is in the neutral gear selection location.

10. The poly-stable electronic shifter assembly of claim 9, wherein the reverse and neutral gear selection locations are between the park and drive gear selection locations.

11. The poly-stable electronic shifter assembly of claim 10, wherein an overall distance that the poly-stable shift lever moves along the axial path from the reverse gear selection location to the drive gear selection location is less than approximately 30 mm, the overall distance being measured relative to the plane.

12. The poly-stable electronic shifter assembly of claim 1, wherein the shift knob includes an upper surface having a first lateral side, an opposed second lateral side, a first portion extending from the first lateral side and a second portion extending from the second lateral, the first portion being smaller than the second portion; and
wherein the PRND indication area comprises the first portion.

13. A poly-stable electronic shifter assembly, comprising:
a poly-stable shift lever coupled to a base proximate a first end of the poly stable shift lever;
a shift knob coupled to the poly-stable shift lever at a second end opposite the first end;
a park, reverse, neutral, and drive (PRND) indication area positioned on an upper end of the shift knob; and
a boot engaging the shift knob and positioned about the poly-stable shift lever such that the boot covers the poly-stable shift lever and conceals a physical location of the poly-stable shift lever when positioned in one of a park, reverse, neutral and drive (PRND) gear selection location;
wherein the PRND indication area is disassociated with the PRND gear selection locations such that the PRND indication area includes an absence of alignment with the physical locations of the poly-stable shift lever in the PRND gear selection locations.

14. The poly-stable electronic shifter assembly of claim 13, wherein the boot includes a first end coupled to a vehicle trim component proximate the base and a second opposite end coupled to a lower end of the shift knob.

15. The poly-stable electronic shifter assembly of claim 13, wherein the poly-stable shift lever is configured to extend through an aperture of and move relative to the vehicle trim component, the aperture being covered by the boot; and
wherein the vehicle trim component includes an absence of the PRND indication area such that the PRND indication area is disassociated with the PRND gear selection locations of the poly-stable shift lever.

16. The poly-stable electronic shifter assembly of claim 15, wherein the vehicle trim component includes one or both of an interior surface panel and a bezel; and
wherein the first end of the boot is fixed relative to the one or both of the interior surface panel and the bezel.

17. The poly-stable electronic shifter assembly of claim 16, wherein the poly-stable shift lever includes a low profile having a height from the one or both of the interior surface panel and the bezel to a lower end of the shift knob of less than approximately 45 mm.

18. The poly-stable electronic shifter assembly of claim 17, wherein the poly-stable shift lever moves along an axial path among the PRND gear selection locations; and
wherein an overall distance that the poly-stable shift lever moves along the axial path from the park gear selection location to the drive gear selection location is less than approximately 50 mm, the overall distance being measured at a plane positioned substantially parallel to the bezel or interior surface panel and adjacent the lower end of the shift knob when the poly-stable shift lever is in the neutral gear selection location and intersecting the poly-stable shift lever.

19. The poly-stable electronic shifter assembly of claim 10, wherein the reverse and neutral gear selection locations are between the park and drive gear selection locations, the neutral gear selection location being between the reverse and drive gear selection locations; and
wherein an overall distance the poly-stable shift lever moves along the axial path from the reverse gear selection location to the drive gear selection location is less than approximately 30 mm, the overall distance being measured at the plane.
